(19) United States
(12) Patent Application Publication
(10) Pub. No.: US 2015/0242947 A1
(43) Pub. Date: Aug. 27, 2015

(54) ELECTRONIC AUCTION FOR OPTIMIZING AN EVENT TICKET SALES PARAMETER

(71) Applicants: Kalyn A. Wilson, Murphy, TX (US); Kelce S. Wilson, Murphy, TX (US)

(72) Inventors: Kalyn A. Wilson, Murphy, TX (US); Kelce S. Wilson, Murphy, TX (US)

(21) Appl. No.: 14/708,267

(22) Filed: May 10, 2015

(51) Int. Cl. G06Q 30/08; G06F 17/30; G06Q 10/02

(52) U.S. Cl. CPC G06Q 30/08; G06Q 10/02; G06F 17/30864

(57) ABSTRACT

Systems and methods are described for electronic auction of event tickets that permit bidders to bid on a plurality of mutually exclusive ticket options without worry about having to purchase more tickets than desired. The systems and methods also direct collected ticket revenue away from ticket resellers, and toward the event organizers and performers. In an exemplary auction, each bidder places bids for multiple seating options at different locations in the venue. A novel system then calculates which sets of seats should be won by which bidders, in order to optimize auction results according to parameters selected by the auction host. It is possible for a bidder to win tickets for a desired set of seats without being the highest bidder, if the higher bidders for that same set of seats had each won for their own bids on different sets of seats elsewhere in the venue.

### TECHNICAL FIELD

The invention relates generally to data processing: financial, business practice, management, or cost/price determination. More specifically, and not by any way of limitation, this invention relates to automated electrical financial or business practice or management arrangement, for example electronic shopping by auction.

### BACKGROUND

Ticket resellers make profits by exploiting their ability to race ahead of most hopeful event attendees and buy up large blocks of desirable tickets before the hopeful attendees can complete a purchase transaction for their preferred reserved seats. The ticket resellers then sell those tickets for a huge price mark-up to the same people who had been shut out by the resellers' rapid block purchases. The hopeful event attendees pay a high price over the face value of the ticket merely because the ticket resellers were able to purchase the tickets earlier. The ticket resellers' profits are not a result of any added value, but merely the result of being able to purchase tickets rapidly and taking on an often negligible risk of being stuck with some unsold inventory.

Although a case can be made that the final prices paid by the hopeful event attendees might properly reflect the true market prices of the tickets, there is still a huge inefficiency in the market: The reseller mark-up is a profit that is lost to the event organizer, but may more properly belong to the event organizer and thus be available to be paid to the event performers. That is, there is often no way for a performer to receive any portion of the true market value of any ticket that exceeds the price paid by a ticket reseller.

As a rather simple example, consider the situation in which a musical group is scheduled to perform in an arena in some city. The arena's ticket outlet venue might sell tickets to the concert for $100 per seat. A ticket reseller purchases 1,000 seats of the most desirable reserved seats. Any hopeful concert attendees who then attempt to purchase a ticket from the arena's ticket outlet venue will not be able to obtain a ticket for one of the more desirable seats, and so must either settle for a less-desirable seat or pay the ticket reseller's inflated price. Perhaps a hopeful concert attendee purchases a pair of tickets from the ticket reseller for $300 each, and is happy with the purchase because the reserved seats at the event will be well worth that price to the hopeful concert attendee.

No problem, right?

Wrong. Someone is missing out on money that has been diverted from its proper destination. The musical group, who will perform a concert that provides an experience worth $300 to each of the people in those seats, only receives a portion of the initial $100 sales price, i.e., the price at which the event organizer sold the tickets to the ticket reseller. This is because the event organizer, who pays the musical group, cannot collect on the additional $200 profit that the ticket reseller enjoys, even though it is the musical group—and not the ticket reseller—that will make the experience so valuable for the concert attendees.

In a more equitable system, the ticket reselling industry would nearly vanish, and the profits, that are currently diverted into the non-productive endeavor or merely purchasing and reselling tickets, could be reclaimed by the performers, event organizers and arena owners. This more sensible and equitable distribution of ticket profits, to those who are actually responsible for the event being possible, could improve the quality of arena accommodations, as well as increase the number of events by better compensating the performers.

The fact that this inefficiency continues to exist yet today is evidence of a long-felt need there is a persistent, on-going problem that is recognized, but not yet solved, by others: a need to more equitably allocate the true market value of event tickets, such as concert tickets, by shifting profits away from ticket resellers and to event organizers and performers. If performers and box office managers had already identified an effective system to reclaim profits that are currently being forfeited to ticket resellers, they would have implemented it already, due to the large profit motive. Alternatively, if such a system were obvious, it would have been developed and implemented by those having the profit motive to do so—unless performers and arena owners deliberately choose to forgo profits that are otherwise obvious to reclaim.

Current electronic auctions for users to bid on event tickets have multiple serious shortcomings. First of all, the money typically goes to ticket resellers rather than performers, as event organizers typically forego auctions in favor of a simple “first come, first served” ticket sales model. Additionally, bidders are afraid to bid too high on multiple possible ticket packages, out of fear that they will win multiple auctions and then be committed to purchase too many tickets. A solution is needed to overcome these problems.

### BRIEF DESCRIPTION OF THE DRAWINGS

For a more complete understanding of the present invention, reference is now made to the following descriptions taken in conjunction with the accompanying drawings:

FIG. 1 illustrates a flowchart of a method for performing an electronic auction.

FIG. 2 illustrates another flowchart of a method for performing an electronic auction.

FIG. 3 illustrates a screenshot presented to a potential auction bidder, for example the view of an internet browser when visiting an auction website.

FIGS. 4A and 4B illustrate a graphical user interface (GUI) seat selection window presented to a potential bidder.

FIGS. 5A and 5B illustrate the seat selection windows of FIGS. 4A and 4, but with indications that some seats have been selected for a bid.

FIG. 6A illustrates a more close-up view of the selected seats from FIGS. 5A and 5B.

FIGS. 6B and 6C illustrates a set of alternative bids that overlap with the bid indicated by FIG. 6A.

FIG. 7 illustrates a bid with non-contiguous seats.

FIG. 8 illustrates a window that controls automatic generation of alternative bids, for example the generation of the bids indicated in FIGS. 6B and 6C, when using the bid indicated in FIG. 6A as a baseline bid.

FIGS. 9A-C illustrate bid account summary windows, as viewed by a bidder when managing multiple bids.

FIGS. 10A-E together illustrate a menu hierarchy for a user to manage multiple bid accounts and bids.

FIG. 11 illustrates a GUI control window for the auction controller (not a bidder) to use for performing the auction calculations and bid acceptance decisions.

FIG. 12 illustrates another flowchart of a method for performing an electronic auction.

FIG. 13 illustrates a computer system for performing electronic auctions.

### DETAILED DESCRIPTION OF THE INVENTION

### Glossary

Bid—A request to purchase a set of event tickets for a particular offer price. The seats that correspond to the event tickets do not necessarily need to be contiguous (although they may be), but may instead be in disparate locations. In actual practice, one or more databases holds records of the bids. To clarify, a single bid record in a database can (and usually will) contain requests to purchase multiple seat tickets, and the offer price per seat for the different seats does not necessarily need to be the same within a particular bid.

Set of mutually exclusive bids—A plurality, more than just one, of bids for which only one is to be accepted. Upon any bid within a set of mutually exclusive bids being accepted, all other bids within that same set are canceled. In actual practice, the bid records for a set of mutually exclusive bids are linked by references in a database, so that during an operation on one of the bid records in a set, the other records can be easily located and operated upon.

Overlapping bids—Bids that have at least one seat in common for the same event date and time. Seat selections do not overlap for the purpose of an auction, if they are separated by time. When a bid is accepted, all overlapping bids will be canceled, in order to avoid selling the same seat multiple times for the same event. A single bid account may contain overlapping bids. In general, overlapping bids may be found in both the same bid account and different bid accounts. Non-overlapping bids are bids that do not have at least one seat in common for the same event date and time.

Baseline Bid—A bid that serves as a basis for an automatically generated additional bid for the same bid account. For example, a person may bid on a first set of four contiguous seats in a particular row of a particular section in an event venue. That person may be willing to accept any set of four contiguous seats within that same row of that same section. So, to avoid that person having to generate one bid for every possible set of four contiguous seats, the computer system may accept the single baseline bid for four contiguous seats in that row of that section and, as a convenience to the bidders, the computer system can automatically generate the alternative bids. The alternative bids do not necessarily need to have the same per seat offers, because seats on the end of a row (offering easier exit to an aisle) may be more valuable to some people than seats in the middle of that same row. Additionally, seats that are centered on a stage may be more valuable to some people than seats to the side of the stage in that same row.

Accepting a bid—A reservation by the computer system as part of a sales configuration that the particular accepted bid will be honored. In actual practice, bids are listed as records in a database or a set of databases; those records will contain a field for which a flag can be set to indicate acceptance. An acceptance of a bid can be provisional or final.

Provisionally accepting a bid—Accepting a bid as part of candidate sales configuration. The computer system can test multiple candidate sales configurations, ascertain the sales parameter for each one, and then select one of the candidate sales configurations as the final sales configuration. The provisionally accepted bids in the final sales configuration become finally accepted bids.

Finally accepting a bid—For a bid that has been accepted in a particular sales configuration, selecting that sales configuration as the final sales configuration. In the database, the flag that indicates acceptance might differently indicate provisional acceptance and final acceptance.

Canceling a bid—Removing a bid from future consideration for acceptance. In actual practice, bids are listed as records in a database or a set of databases; those records will contain a field for which a flag can be set to indicate cancelation. This field may be the same as is used to indicate acceptance. Cancelation of a bid may be provisional or final.

Provisionally canceling a bid—Removing a bid from future consideration for acceptance only within the current sales configuration test. Provisionally canceling a bid during one sales configuration test does not permanently cancel that bid for other sales configuration tests. A bid is only finally canceled when the final sales configuration is selected.

Finally canceling a bid—All bids that are not finally accepted, as part of selecting the final sales configuration, are finally canceled and the auction is then complete for those bids. In some situations, finally canceled bids may be copied into a new auction. This could occur, for example, if the sales transaction for a finally accepted bid was not completed, and the seats that were the subject of that incomplete transaction were carried into a subsequent auction. For convenience of the bidders, finally canceled bids that could be relevant in a subsequent auction might be carried forward.

Bid account—The unit for defining a set of mutually exclusive bids. A particular user of the system may have more than one bid account. If a single user has two bid accounts, and those bid accounts are not themselves logically linked as mutually exclusive, then acceptance of a bid in the first account does not result in cancelation of non-overlapping bids in the second account. Essentially then, for the purposes of the auction calculations, a single user with two bid accounts effectively becomes two separate bidders.

Bid window—A time period, having a defined start and stop time, during which bids will be accepted at a website or other computer system that is connected to the internet (i.e., a network node). There may be times within the bid window that acceptance of bids is temporarily suspended. Examples of suspensions within a bid window include computer system maintenance, both planned and unplanned; computer system crashes; and ceasing to accept bids outside of business hours or during a holiday. The bid window open times are defined by the periods during which the network node is operable to accept incoming bids. The computer system will have software that is capable of taking incoming messages, storing data extracted from those messages in memory, analyzing that data for compliance with certain requirements, and responsive to that compliance, returning an acknowledgement of success or failure of a bid request. When this software is operating to be able to accept incoming messages that correspond to bids in an electronic auction, the bid window is open for that particular electronic auction. Thus, the start time is the initial time the bid window is open for a particular auction, and the stop time is the closure of the final open time segment.

Sales configuration—A set of accepted bids. In rare situations, a sales configuration may be a single bid, but in most situations, a sales configuration will contain a plurality, more than one, of accepted bids.

Candidate sales configuration—One of a plurality, more than one, sales configuration that is tested by the computer system to ascertain the value of a sales parameter. A candidate sales configuration has provisionally accepted bids.

Final sales configuration—One of the candidate sales configurations that is selected as the one which optimizes a sale parameter. When the final sales configuration has been selected, the computer system has identified all of the bids that will be finally accepted for that auction. A final sales configuration does not need to accept all possible acceptable bids, as the event organizers may be planning a series of auctions, in order to sell tickets in stages.

Sales parameter—A metric, or combination of metrics, of a sales configuration that is to be optimized by the computer system. One example of a sales parameter is the sales amount measured in currency; another exemplary sales parameter is the number of seats sold.

Optimizing a sales parameter—Maximizing or minimizing a sales parameter, possibly with constraints, such as a maximum number of tested candidate sales configurations, exhausting all options of a testing plan, or some other constraint. Perhaps in most situations, optimizing a sales parameter will be maximizing the monetary amount of sales, although in some situations, optimizing a sales parameter will be maximizing the number of seats sold. One example of optimizing a combination of metrics is maximizing the ratio of the monetary amount of sales divided by the number of seats sold. This maximizes the average per-seat revenue. Another example of optimizing a combination of metrics is maximizing the monetary amount of sales subject to not exceeding a threshold number of seats sold. Optimization does not need to be a global optimization. For example, genetic algorithms, which are a common method of parameter optimization and could be used with this inventive system, are known to be non-exhaustive testing and thus provide only a local optimization with the certainty of having achieved the global optimization defined in terms of a confidence level.

Not optimizing the sales parameter for event tickets included in a finally accepted bid—A bid is finally accepted for some event tickets that do not, themselves, optimize the sales parameter. This occurs because the sales parameter is optimized at the sales configuration (aggregated sales) level, rather than at the individual bid or seat level. For example, in the situation that optimizing a sales parameter is maximizing the monetary amount of ticket sales, the invention specifically contemplates that at least some seats will be sold to a bid account that is not the highest bidder. This can occur when the highest bidder on a first set of seats wins a bid on a second (different, non-overlapping) set of seats, and thus the highest bid for the first set of seats is canceled. Thus, a bid for the first set of seats, that was not the highest bid at the closing of the bid window, can actually win the first set of seats, despite the existence of the higher bid. This can also occur if the highest bid on a particular set of seats then cancels other bids in the same bid account that would have provided more revenue than competing bids. As a more detailed example, consider that bid account X offers $100 for each seat in a first bid on four seats, and $90 for each seat in a second set of four seats in a different row. Because these bids are in the same bid account, only one of them will be accepted and the other will be canceled. Now consider further that there is a first competing bid from bid account Y that overlaps exactly with X′s first bid and offers $95 for each of those same four seats, and a second competing bid from a bid account Z that overlaps exactly with X′s second bid and offers $80 for each of those same seats. Acceptance of X′s first bid results in cancelation of X′s second bid and acceptance of Z′s bid, providing $100×4+$80×4=$720. However, acceptance of X′s second bid results in cancelation of X′s first bid and acceptance of Y′s bid, providing $95×4+$90×4=$740. Thus, sales revenue is optimized for the auction by rejecting the $100 per seat bid in favor of the $95 per seat bid. This is an example of not optimizing the sales parameter for event tickets included in a finally accepted bid, because for the set of four seats in X′s first bid, optimizing the sales parameter for those particular four seats would have required accepting the $100 per seat bid instead of the $95 per seat bid.

Seat—A defined location within some venue, for example a particular numbered seat in an arena or performance hall. A seat may be sold for a particular single event, such as a single concert, or for a series of events, such as season tickets.

### Narrative of the Figures

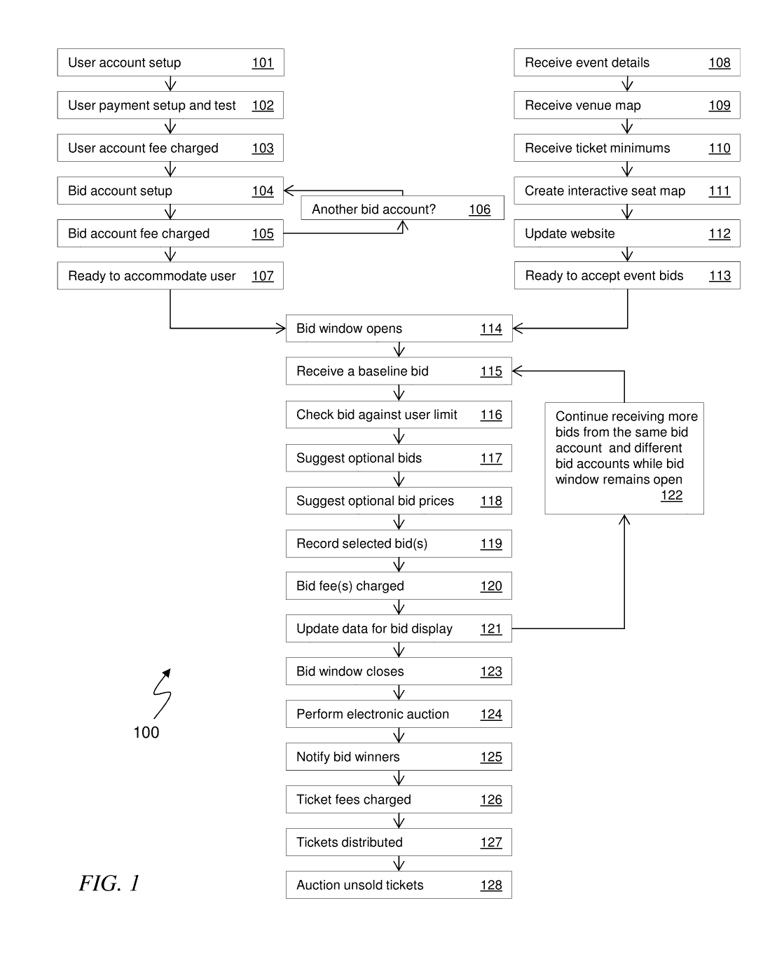

FIG. 1 illustrates a method 100 for performing an electronic auction. In box 101 a user sets up an account. In practice, a website is provided in which a person can create a user account with identifying information linking the person, or possibly some business entity, with the account. In box 102, the user sets up payment information, such as entering credit card or other payment account information. A computer system hosting the account website (or connected to the website computer) may test the payment credentials to determine whether the account information is legitimate and correct. Anti-fraud systems may be utilized in order to ensure that the account setup is not attempting to use stolen payment credentials.

In box 103, a fee is charged to set up the user account. This is optional, but may be used as a measure to prevent automatic generation of large numbers of bid accounts in an attempt amounts crash the account website or to prepare for later attempting to perform some exploit of the auction calculation process. Although in many current online auction systems, bidders do not typically pay to create bidding accounts, bidders may acceptable the fees if the amount is modest and provides users with some level of certainty that the auction process will be fair. In box 104, a user sets up a bid account. This is a separate process than user account setup in some auctions, to allow for a user to have multiple bid accounts. Thus, there is a hierarchy: a single user account can contain multiple bid accounts that each can contain multiple bids. A user account can be persistent, that is, it may survive after an auction to be used for later auctions. Bid accounts may be similar to a user account, in that they may be persistent and survive for multiple auctions. In general, though, bids will only exist specifically for a particular auction and be canceled after the auction, if not accepted. There can be some exceptions, as noted in the glossary for the phrase “Finally canceling a bid.” As with a user account, a fee may be charged per bid account, as indicated in box 105. The fee should preferably be modest, low enough to not upset users, but high enough to discourage generation of a large number of separate bid accounts by people who wish to perform some exploit.

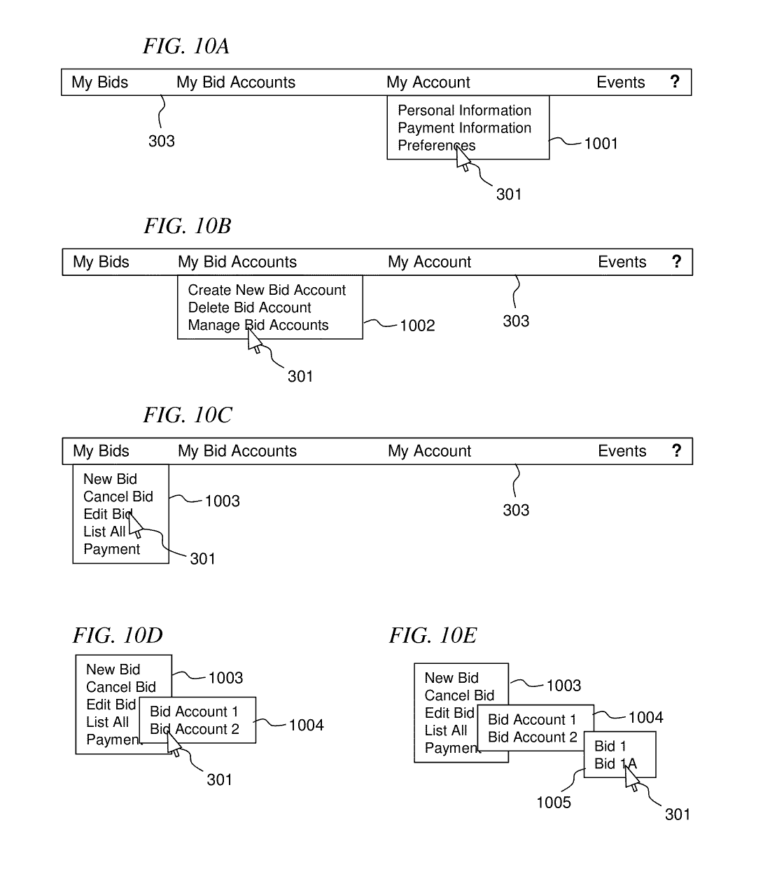

In box 106, the user is able to set up another bid account, returning to box 104. The different bid accounts may be given different names by the user, or automatically named by the website, based on how the system is implemented. The processes of boxes 101-106 may be controlled by a graphical user interface (GUI) having a menu system as described later in FIGS. 10A-E. In box 107, the user is ready to bid in a current or future auction. That is, the user is ready to become a bidder.

The other side of the auction preparation will now be described. In box 108, the auction host, who will be preparing any websites to accept bids, receives event details, such as the date and artist name. In box 109, the auction host obtains an electronic map of the venue with seat selection capability. In practice, this will be a GUI map with zones that are linked to particular seats, and a user clicking on a particular location within the map creates one or more entries in a database that indicate the user's selection. In box 110, the auction host receives indication of ticket price minimums, if there are any. Price minimums may optionally be seat or section specific.

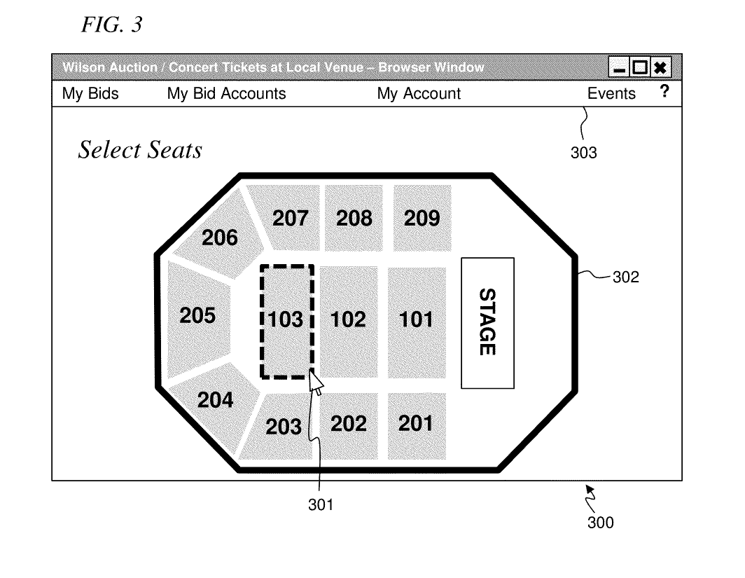

In box 111, the auction host creates an interactive seat map capable of generating images equivalent to at least some of those illustrated in FIGS. 3-6C and 8 (described later). The seat map may optionally be hierarchical, providing first a section selection and then a finer detail for seat selection. In box 112, the auction host posts the seat map to a computer system holding the auction website, and performs other tasks necessary to prepare the auction website to receive bids from users. In box 113, the auction host is ready for the auction, waiting only for any final matters for opening the bid window.

In box 114, the bid window opens. It should be noted that, apart from corrections or updates, the processes in boxes 108-113 must have been sufficiently completed prior to method 100 entering box 114. However, new users can run through the processes of boxes 101-107 after box 114 has opened the bid window. In actual practice, box 114 may be as simple as setting some logical flags in the website management data to activate bid acceptance controls in the GUI presented to users, although more complex requirements may exist.

With the bid window open, and some users having completed account setup, a first baseline bid is accepted in box 115. The bid is called a baseline bid to distinguish bids entered by a bidder from bids that are automatically generated for user convenience. In box 116, the baseline bid is checked against a bidder's limit. The limits can include the number of bids entered and the currency amount of bid as either the total amount or on a per-seat basis. Because many internet-based electronic processes, such as auctions, are susceptible to exploit by automated processes, the auction host may wish to prevent a malicious party from entering a large number of bids. So the auction host may limit the number of bids per bid account to some maximum.

Additionally, there is another potential malicious exploit that can disrupt an electronic auction. A malicious actor may set up an account using a credit card having a low credit limit or using a debit card having only a limited amount of funds. When the auction is performed and the malicious actor wins a particular bid, the other bids for the same seats (overlapping bids) are canceled. Then, when the auction host attempts to complete the sales transaction, the payment will be declined. One of the other bidders, whose bid had been canceled, then loses the seats that bidder should have been permitted to purchase. This is an undesirable perturbation and exploit of the electronic auction. One possible solution it to re-auction the unsold seats (as indicated later, in box 128) or to intertwine final bid acceptance with the ticket sales transactions (meaning that boxes 124-127 are performed in a loop on a per-bid basis). Another possible solution, implemented in box 116 (or as part of box 124) is to perform a transaction reservation or credit inquiry for the highest possible charges associated with a user account. This is similar to a car rental company reserving a charge amount (called a “hold”) on a debit card during the rental period, and finalizing the exact charges some days later, when the renter returns the car. Additionally, restaurants often make a provisional charge of a diner's bill amount plus some percentage for a tip, prior to receiving the signed charge slip from the diner that shows the final amount of the tip and the total authorized charge. The auction host may utilize similar measures to ensure that a bid winner can pay, if successful.

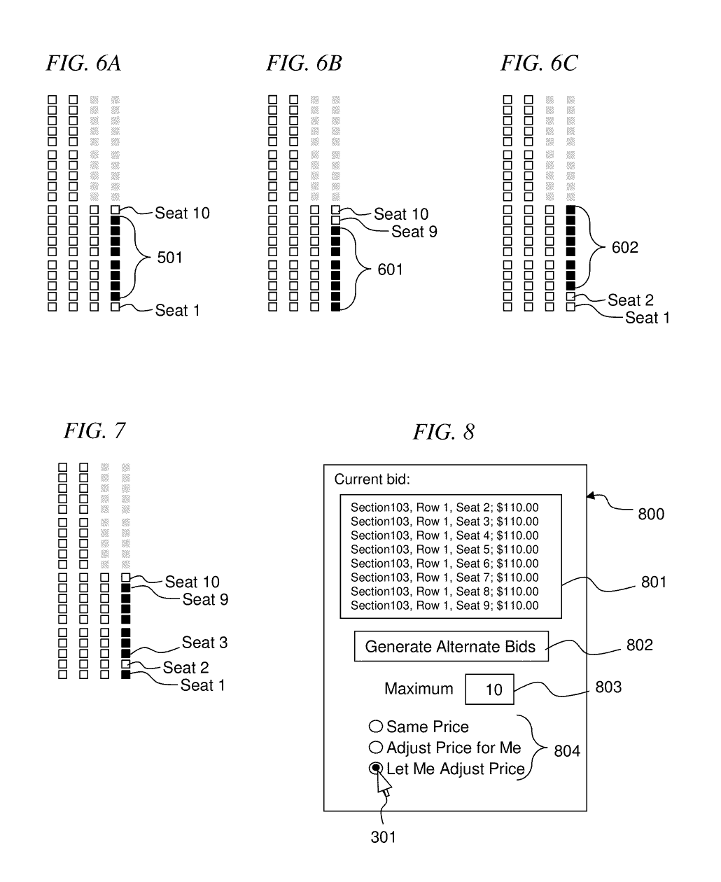

In box 117, the website computer system may suggest additional bids to complement the baseline bid received in box 115. More detail on this process is provided later, in the descriptions of FIGS. 6B-7. The purpose of these additional bids is to attempt to accommodate a bidder's general preferences, if the exact baseline bid is not accepted. An example is that a bidder may bid on some seats in a particular row that is a certain distance from the stage, but is willing to accept other seats in the same row and just shifted a few positions toward one side. The automatic generation of additional optional bids is a convenience for the user, to prevent the user from having to endure the tedium of entering every acceptable set of seats as an additional bid. In box 118, prices are suggested for the optional bids. The process may reflect that some seats, even at the same distance from the stage, are worth more than others. For example, in rows that are closer to the stage, seats in the center are typically more desirable and should therefore demand higher prices. However, in rows that are far from the stage, seats close to an aisle may be worth more to people who are concerned about easy access to restrooms and concessions.

In box 119, the selected bids are recorded in a database or set of databases, enabling the optional charge for the bids in box 120. The optional bid fees are a possible way to discourage some malicious actors from attempting to overwhelm the auction system or perform some other unfair exploit. Although some bidders may not like the per-bid fee, if the fees are sufficiently modest, users may accept them as a way to ensure a more fair process. Bids fees might be levied only on baseline bids, with a limited number of automatically-generated optional bids entered for free, or perhaps the fees for optional bids might be lower than for the corresponding baseline bid. Additionally, fees, such as for user account setup, bid account setup and bids themselves, might be credited toward the purchase of a winning bid. Several pricing options are available for the auction host to consider when using bid fees to try discouraging exploits.

With the initial round of bidding now complete, a database linked to the interactive seat map is updated in box 121 to reflect that a bid has been recorded. Other bidders may then be able to see the existence, and possibly the currency amount, of the bid. Hopefully this occurs rapidly enough that other bidders, who are using the system concurrently, can see updates in near real time. This information can then assist them with making better-informed bids. If multiple bidders are working at the same time and the seat map updates are rapid enough, the multiple bidders can contemporaneously make updates to their bids until they each reach their highest comfortable amount.

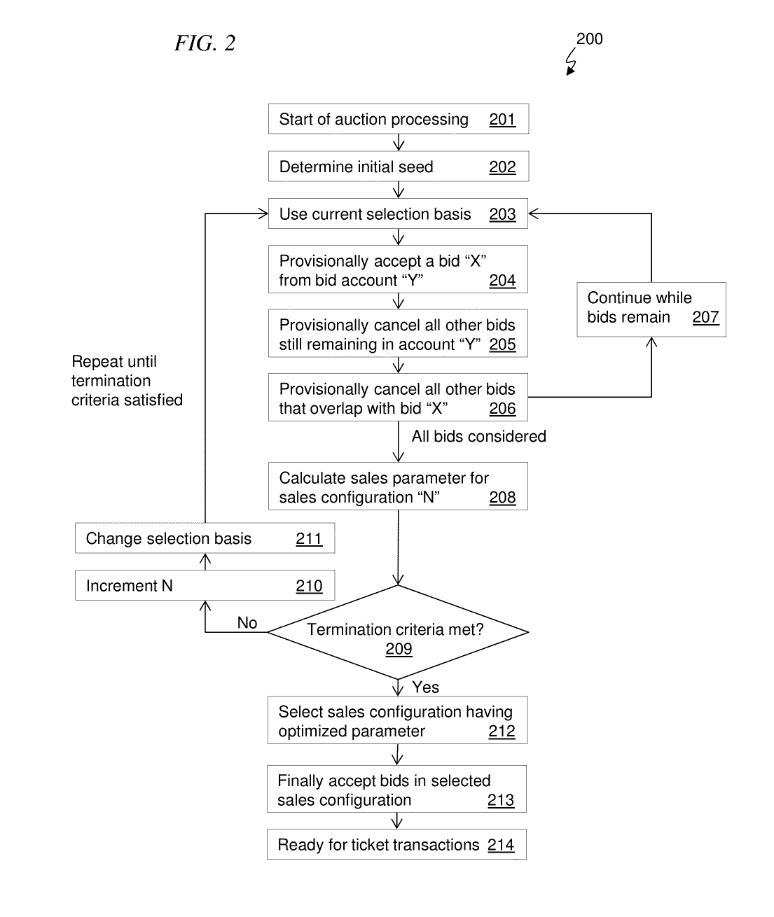

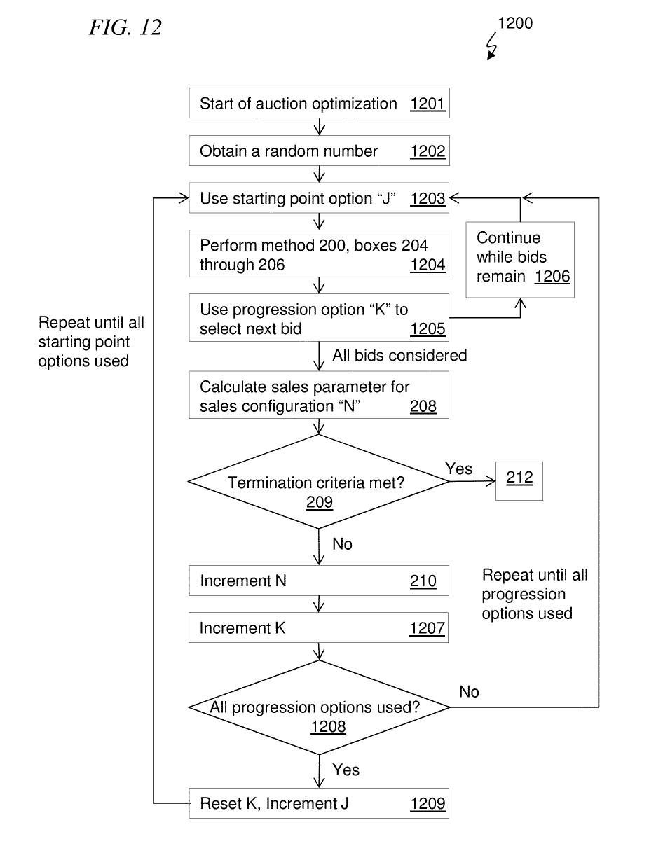

While the bid window remains open, method 100 moves to box 122, cycling through boxes 115-121. There may be temporary suspension in the bid window, for example if maintenance is needed on the auction hosts' computer systems or if the auction hosts will only accept bids during business hours and the bid window is scheduled to span several days. The bid window closes in box 123, and the calculation for the auction may be performed in box 124. More detail on the auction calculations is provided in the descriptions of FIGS. 2 and 12. The description of FIG. 12 follows the description of FIGS. 3-11 so that hopefully, the description of FIG. 12 can benefit from an understanding of the earlier figures.

In box 125, the bid winners are notified, likely through the contact information provided via the user account. It is possible that a user of the auction system may have notifications set to be specific to a particular bid account. For example, the user may have one bid account set up to purchase tickets for work colleagues, with those notifications sent to a work email address, whereas other bid accounts have notifications sent to a personal email address. As part of box 125, losers might also be notified. A notification may include the status of all bids, whether accepted or lost (and canceled), that are associated with a particular bid account or user account.

In box 126, the ticket fees are charged and the tickets are distributed in box 127. It should be noted that the actual financial transactions and ticket distribution processes of boxes 126 and 127 may be contracted to a third party. In such situations, the auction host sends off a list of successful bids to a contracted entity for processing. Optionally, the contracted entity may also perform the notifications of both winning and losing bids, for box 125.

In box 128, another auction is held for unsold tickets, repeating boxes 109 through 127. This can occur when the initial bid window is set for some number of days, and the venue does not sell out. Remaining unsold tickets may then be sold in the conventional method, or put into a later auction according to the inventive method. Additionally, uncompleted transaction from earlier bid winners can be returned to the auction. For later auctions, box 109 can include receiving a database linked to the venue map, and which indicates which seats are sold and which are still open for bidding.

FIG. 2 illustrates a method 200 for performing electronic auction calculations. Additional detail will be provided in FIG. 12, which illustrates a method 1200 that is intertwined with method 200. However, the descriptions of intermediate FIGS. 3-11 provide information that should assist with a better understanding of FIG. 12, when the narrative of the figures reaches that point. In general, method 200 largely fits within box 124 of FIG. 1. The auction host may perform method 200 or contract the calculations to another entity. With computing processes, both calculations and storage, so widely dispersed in existing computerized financial transactions, method 200 should not be interpreted to be limited to operation on only a single computer node that also hosts the bidding website.

Box 201 starts off the auction processing and calculations of the sales parameter value for different candidate sales configurations. In box 202, an initial seed is determined. Part of this process is obtaining a random number. Because genetic algorithms typically require some degree of randomness to create variations in the progression of generations, this seed may be a random number. Genetic algorithms are well-known in the art, and may optionally be utilized as a method for the optimization process. The auction host may seek to optimize a single sales parameter or perhaps some weighted combination of sales parameters, subject to some constraints. Options include maximizing total sales revenue, number of seats sold, and per-seat average revenue.

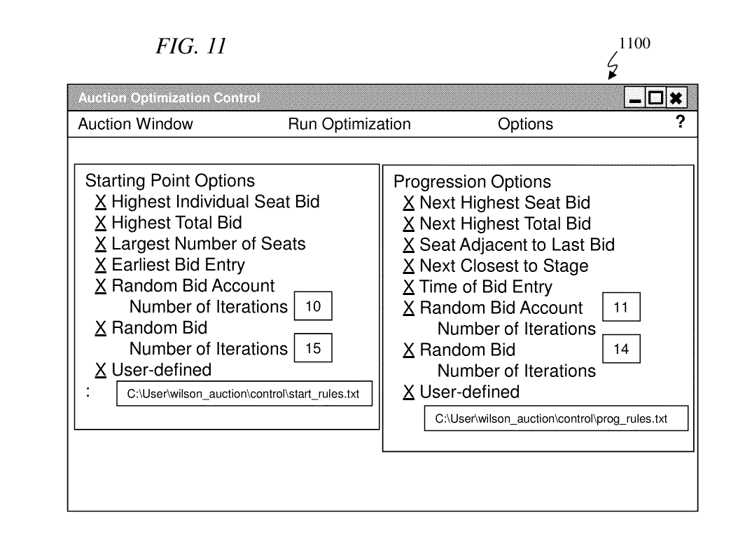

An initial bid selection basis is selected in the first entry of method 200 into box 203. Different bid selection processes may be used in subsequent returns to box 203. Examples of bid selection bases are illustrated in FIG. 11. These form the basis for the auction to proceed with automated consideration of the bids. An example is that, in one sales configuration test, the bid having the highest per-seat offer is provisionally accepted first. Then, after provisional cancelation of all other bids in the bid account and all bids from other bid accounts that overlap with the first provisionally accepted bid, the remaining bid that now has the highest per-seat offer is selected next. Random selections can be used in the event of a tie.

While such a scheme might initially make sense, it could likely leave gaps of unsold seats that would then be sold for lower amounts. So, as an alternative selection basis, the second set of bids considered after the provisional acceptance of the first bid, is instead bids for seats immediately adjacent to the provisionally-accepted bid. That is, the progression method for bid consideration is not highest per-seat bid, but instead location relative to provisionally accepted bids. This selection basis could possibly reduce the likelihood of gaps of unsold seats. In situations in which there is more than one adjacent seat (for example a bid on seats in the center of a row has been accepted, and there are open seats to each side), a random selection can be used, and the non-selected seat returned to at a later time. Which progression method provides the best sales parameter optimization cannot be predicted in general for all auctions, and so the different progression methods should be tested. It should be noted that there may be different criteria for the initial provisional bid acceptance (the starting point) for a particular test of a candidate sales configuration than for considering the second and subsequent bids (the progression method). FIG. 11, described in detail later, illustrates different optional sets for the starting point and progression bases.

With this background, method 200 will be described further. In box 204, a bid X is provisionally accepted from bid account Y. This causes the cancelation of all other bids in bid account Y, indicated in box 205. Additionally, all bids in other bid accounts that overlap with bid X are provisionally canceled in box 206. The bids other than X are only provisionally canceled at this point, because they could be considered and accepted in other candidate sales configurations. The final cancelation for a bid will not occur until it conflicts with a finally accepted bid, at a later point in method 200.

Until all bids are considered, or some other stopping point is encountered, method 200 moves to box 207, which causes a cycling of boxes 203-206. After completion of the cycle, the candidate sales configuration is complete; method 200 enters box 208, enabling calculation of the sales parameter for that candidate sales configuration.

Upon completion of that candidate sales configuration, method 200 must then ascertain whether a sufficient number of candidate sales configurations have been tested that a suitable optimization may be determined. Thus, in box 209, termination criteria is tested. Termination criteria can include that a certain number of candidate sales configurations have been tested, the time set aside for the auction calculations has expired, that the differences between the sales parameter values is below some threshold (i.e., the parameter values are converging), and that all starting point and progression options have been exhaustively tested.

If the termination criteria has not been met, method 200 progresses to box 210, in which the value N, denoting the count of tested candidate sales configurations, is incremented. In box 211, the selection basis can be changed to cause the subsequently tested candidate sales configuration to be different. During the process indicated by box 211, the starting point, the progression method, or both, may change. Additionally, a different random number may be selected, since entropy will likely be needed for the process of selecting the sequence of bid consideration. After box 211, method 200 returns to box 203.

When the termination criteria is met, method 200 moves to box 212 to select the candidate sales configuration that best matches the auction host's desired optimization. In box 213, the bids that had been provisionally accepted in the selected sales configuration are finally accepted, and the provisionally canceled bids are finally canceled. In actual practice, there may be either a database holding the bids and flags for each candidate sales configuration, or possibly a copy of the bid database for each sales configuration, with a flag indicating whether each bid had been provisionally accepted or canceled. Final selection of a sales configuration could include altering the flags from indicating provisional disposition to final disposition, or else cleaning up unneeded information for the non-selected candidate sales configurations. In any case, the final acceptance or cancelation is contained as annotations in one or more databases, so that the ticket processing can properly avoid selling duplicate tickets. Method 200 completes with box 214, in which the auction host is ready for the ticket transactions.

Turning now to FIG. 3, the user experience will now be described. FIG. 3 illustrates a screenshot of a GUI window 300 that is presented to a potential auction bidder, for example the view of an internet browser when visiting an auction website. In some exemplary embodiments, FIG. 3 could represent the GUI of a software application that displays pre-loaded data to a bidder, and communicates with the auction hosts' computer system for obtaining updates on existing bids and then sending in bid messages.

GUI window 300 indicates that cursor 301 is selecting seating section 103 in venue seating map 302. A GUI menu bar 303 appears at the top of the screen, and will be described in more detail later, in the descriptions of FIGS. 10A-E. It should be noted that computer interfaces vary widely, and there are many different presentation and user input schemes that could perform the same communication function as GUI window 300, while having a markedly different appearance. Venue seat map 302 is a large scale seat map, and not suitable for selecting individual seats. In this example, the seat map is multi-scale or hierarchical, with venue seat map 302 being a high level map. It is not necessary for some embodiments to have a multi-tiered seat map.

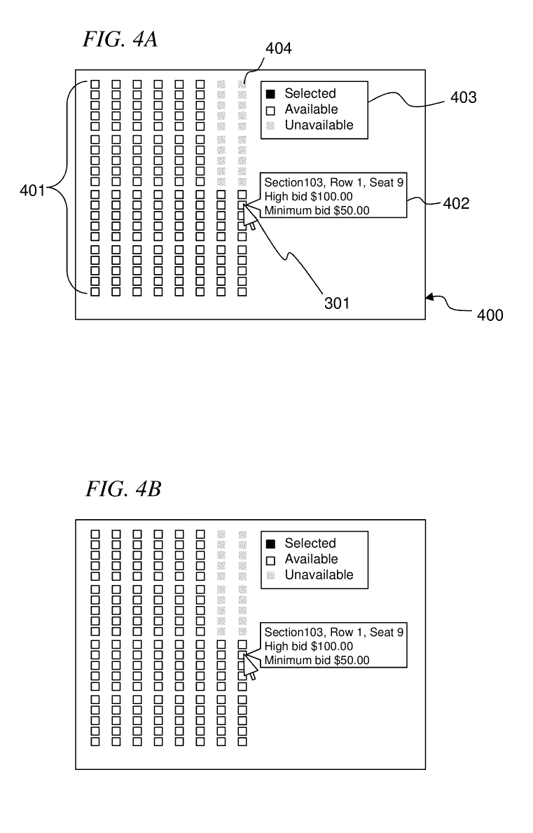

FIGS. 4A and 4B illustrate a seat selection window 400 that is presented to a potential auction bidder, which is a finer scale seat map. In some embodiments, a bidder selecting a section in venue seat map 302 will trigger the seat selection software to display seat selection window 400, having seats that correspond to the seating seat selected on venue seat map 302. It should be noted that the software to swap between seat views could be running either on the bidder's computing device or on the auction host's computer system, with the results sent to the bidder as a webpage update. It should also be noted that seat selection systems vary widely, and the illustrated embodiments are merely examples. Some seat selection systems display both large scale and fine scale maps simultaneously.

FIGS. 4A and 4B illustrate the same seat selection window 400, however for clarity, FIG. 4A has annotations and FIG. 4B is left clean of annotations. This permits more ready identification of the text that appears to the bidder, and the markings used to explain in the patent figures.

Seat selection window 400 has a block of seats 401, a seat information box 402, a seat legend box 403, and a set of grayed out seats 404. Cursor 301 is pointing to a seat within seat block 401, triggering the software to display information for that particular seat in seat information box 402. As cursor 301 moves off of that seat, seat information box 402 will disappear. If cursor 301 moves to a different seat, a new manifestation of seat information box 402 will appear, showing the equivalent information for that different seat. Seat information box 402 contains an identification of the particular seat (“Section 103, Row 1, Seat 9”), the current high bid (“High bid $100.00”), and the minimum bid that the auction host will accept for that seat (“Minimum bid $50.00”). This minimum bid is often referred to as a reserve amount.

The grayed out seats 404 are unavailable, according to seat legend box 403. This could be because they had been sold in a previous auction, or were not made available to the auction host. Or, perhaps concurrent with the auction bid window, there is a “buy it now” feature that permits users to purchase some seats immediately for a sufficiently high price that the event organizers will take without requiring an auction. If that is the case, those seats could have been sold through that concurrent sales offer. In any case, seat selection window 400 is showing information that requires timely update, in order to make the auction bidding experience more fair and productive. This updated information includes seat availability, such as the grayed out seats not being available for the auction, and also the amount of the current high bid. If the potential bidder makes a bid for the selected seat that is above $100, then other potential bidders who are currently in the process of placing bids should preferably see the new high bid, so that they can adjust their own bids and expectations accordingly.

It should be noted that, because of the nature of this type of auction, termed here a “Wilson auction”, a bidder does not need to beat or even match the current high bid in order to have a chance of winning the auction for the desired seats. If the current high bidder wins on a different bid, then a lower bid could possibly win the auction for a specific set of seats. This is a notable difference from other computerized auctions: a higher bid for a particular seat could be automatically eliminated from consideration seat by that bidder winning another seat elsewhere in the same auction event. Who wins this particular seat, in this example, is integrally tied to whether any of the bidders win seats elsewhere, rather than merely by who bids the highest amount. In the inventive system, the determinations of the winners are integrated and intertwined, because the different seat award possibilities are calculated together.

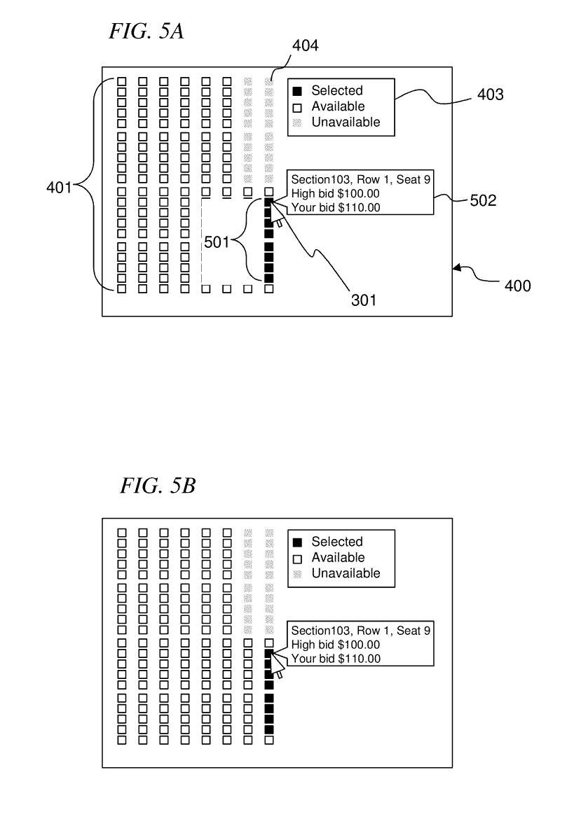

FIGS. 5A and 5B illustrate the seat selection windows of FIGS. 4A and 4, but with indications that some seats have been selected for a bid. Seat bid block 501 is darkened which, according to seat legend box 403, indicates that these seats have been selected for a bid. A bid can be for a single seat or have a set of offers for multiple seats, as indicated. In the illustrated example, seat bid block 501 indicates that 8 seats are included in the current bid. It should be noted that this is merely an example; a different number of seats could have been selected. Additionally, seat legend box 403 should be interpreted as merely one possible display scheme. Further, within a single bid, the offers for different seats may be different. For example, one seat may have an offer of $110, while another seat in that same set of seats involved in the bid may have an offer of $90.

With a bid entered, a new type of information box appears when cursor 301 moves over a particular seat. Seat information box 502 is illustrated as showing the current bidder's offer for the particular seat (“Your bid $110.00”). As cursor 301 moves around seat selection window 400, seat information box 502 will pop up for seats that are part of an existing bid and seat information box 402 will pop up for seats that are not part of an existing bid. It should be noted that other or additional information could be present in information boxes 402 and 502.

Entry of an offer for a seat, as part of a bid, can be performed in a myriad of different ways. Selection of seats in online ticketing systems is well-known and varies widely. Additionally, there are multiple ways to create, alter and cancel bids in online auctions. One exemplary method that could be used for the inventive system is to accept an offer for a seat within seat information box 402, and when the bidder has completed entering the offer amount and exits the editing mode, seat information box 402 becomes seat information box 502. A possible user interaction could occur in this manner: As cursor 301 hovers over a seat, seat information box 402 appears for that seat, but initially in a read-only mode. When the bidder clicks the mouse (or otherwise indicates a selection with an equivalent editing control), seat information box 402 changes to an edit mode. Either an offer entry text entry window is separately available, or perhaps the label “Minimum bid” becomes “Enter your bid” and the minimum bid amount display becomes an editable text entry window. Optionally, the editable text entry window could be programmed to accept only amounts equal to or above the minimum bid. Upon the bidder finishing the entry of the offer amount, and exiting seat information box 402, the seat offer is added to the currently open bid. The newly-created seat information box 502 could be similarly editable upon selection by a bidder, in order for the bidder to make adjustments to the offer price.

A bidder may wish to edit an offer for a seat during the initial bid setup, and also at a later time during the auction window, if the bidder notices that other bids are higher. For example, perhaps a bidder saw that a particular seat had a minimum bid of $50, and a current high bid of $100. The bidder could then offer $110 for that same seat. If, in this example, the auction bid window was open for a week, then the bidder may wish to review the bid for competitiveness a few days later. While doing so, using the seat selection window 400, the bidder moves cursor 301 over that seat, and seat information box 502 appears. The bidder may notice that the current high bid is now $200. Clicking the mouse, the bidder activates the edit mode of seat information box 502 and edits the bid to change the offer amount from $110 to $210. Any automatically generated alternative bids that are linked to this baseline bid could then optionally be automatically adjusted by the same amount (increasing by $100, in this example) as a convenience to the bidder.

FIG. 6A illustrates a more close-up view of the selected seats from FIGS. 5A and 5B. In addition to the annotation of seat bid block 501, seat numbers 1 and 10 are also indicated by annotation. This is to help explain the optional alternative overlapping bids that are illustrated in FIGS. 6B and 6C. In FIG. 6B, a seat bid block 601 is indicated, and a seat bid block 602 is indicated in FIG. 6C. It can be easily understood that there are 10 seats available, but the current bidder desired only eight. So there are three options to get a set of contiguous seats in exemplary row 1 of section 103. These options are: (A) seats 2-9, with seats 1 and 10 empty, as in seat bid block 501; (B) seats 1-8, with seats 9 and 10 empty, as in seat bid block 601; and (C) seats 3-10, with seats 1 and 2 empty, as in seat bid block 602.

FIG. 7 illustrates a bid with non-contiguous seats, which may be permissible in some embodiments. This type of seat purchase pattern, and also the pattern indicated by seat bid block 501, is used by some people to attempt obtaining an empty seat immediately adjacent to their own. In a seat selection scheme in which seats are purchased immediately, some people attempt to leave single seats to the side of their own block of seats, or sometimes within their own block. Their rationale is that most people attend concerts and other events in pairs or groups, and do not wish to sit alone among strangers. So there is a chance that single seats could go unpurchased and thus remain empty during the event. This scheme reduces both the number of people who will attend the event, and the amount of money that the event organizers collect.

While such a scheme often works for ticket sales systems that sell seats immediately, it is less likely to work in the inventive system. That is because there may be other bids on the same set of seats that completely fill the block of 10 seats, and do not leave any empty. If the auction host attempts to maximize the number of seats sold, then a bidding scheme that leaves empty single seats is unlikely to win. If the auction host attempts to maximize the revenue, then a bidding scheme that leaves empty single seats must bid sufficiently high to beat out competing bids that have offers on all of the seats in the block (either a single bid or a set of complementary bids from different bid accounts). Thus, the inventive system discourages gaming seat selections to attempt leaving single empty seats.

Turning now to FIG. 8, a window that controls automatic generation of alternative bids is illustrated. For example, perhaps a bidder had manually entered the bid indicated by seat bid block 501, and recognizes that other seat blocks could provide effectively the same viewing experience, being in the same row and thus about the same distance from the stage. In order to avoid the bidder needing to manually enter the bids illustrated in FIGS. 6B and 6C, as seat bid blocks 601 and 602, an alternative bid generation control window 800 may optionally be provided for the bidder.

Within alternative bid generation control window 800 is a bid summary window 801, a bid generation control button 802, a bid option text entry window 803, and bid option control panel 804. Bid summary window 801 illustrates the exemplary bid that has been used to describe some of the previous figures. There are eight seat offers illustrated in the exemplary baseline bid, each for row 1 in section 103, and the bidder is offering $110 for each seat. The seats selected are seat numbers 2 through 9, which corresponds with the exemplary user selections of FIGS. 3, 5A, 5B and 6A. Although each seat offer is illustrated as the same amount, $110, this is not a requirement for making a bid. Bid option text entry window 803 is illustrated as containing a value, 10, for limiting the number of automatically generated alternative bids.

A relatively simple way to control the automatic bid generation process is to select blocks of contiguous seats, the same number as in the baseline bid, but 1 seat shifted in either possible direction, until either the selected maximum count is reached or there are no other available blocks. In this exemplary situation, although the bidder has opted to generate up to 10 alternative bids, only two alternative bids are possible with the described simple system: a shift of one seat to the left and a shift of one seat to the right. These would result in the bid configurations illustrated in FIGS. 6B and 6C, which were described earlier. Other automatic bid generation schemes are available, such as including rows to the front and behind, and seats in a different seating section that are the same distance from the stage and minor the offset from the center of the venue. For example, temporarily referring now to FIG. 3, a baseline bid in section 204 could possibly be a basis for an automatically generated baseline bid for equivalent seats in section 206.

Other options for controlling the generation of automatic bids are illustrated in bid option control panel 804; these relate to pricing. Illustrated options include keeping the same price, automatically adjusting the price, or prompting the bidder to manually enter new prices. In the exemplary embodiment disclosed, even if the bidder selected to have the system keep the same price or automatically adjust the price, all of the bids are editable and the bidder will thus retain ultimate control of the offer price. The illustrated options of keeping the same price or automatically adjusting the price are conveniences for the bidder, to speed the bid generation process. After the bidder has selected the desired options, the bidder moves cursor 301 to bid generation control button 802 and clicks on it, to begin the generation of automatic bids.

Suppose, as part of the example bid being used to describe the figures, the bidder changed the selection from “Let Me Adjust Price” to “Adjust Price for Me” prior to clicking on bid generation control button 802. One possible algorithm for the automatic price adjustment would be to increase the offer for an aisle seat by some amount (whether a fixed minimum or a rounded percentage of the baseline seat offer) for rows beyond some threshold distance from the stage, but increase the offer price for seats that are closer to the center of the stage for rows that are closer than some threshold distance from the stage. Another possible algorithm is that for shifted seat positions that do not include an aisle seat, or are not appreciable closer to the center of the stage, the alternative bid is somewhat lower than the baseline bid (whether a fixed minimum or a rounded percentage of the baseline seat offer).

These two exemplary algorithms produce the following results. For the alternative bid illustrated in FIG. 6B, an aisle seat is included (section 103, row 1, seat 1) that had not been included in the baseline bid (which is illustrated in FIG. 6 A). Because section 103 is relatively far from the stage, this aisle seat is given a price premium of $10, which is approximately a 10% premium over the baseline offer for the rightmost seat ($100). Although the shifted seats are not the bidder's initial selection, they do now include an aisle seat, so the remaining seat offers are unaltered. The total bid amount would then be $110×7+$120=$890.

For the alternative bid illustrated in FIG. 6C, no aisle seat is included, and the shifted seats are not the bidder's initial selection. So this exemplary pricing algorithm may adjust the prices downward. One possible adjustment is to drop the seat offers by $5, which is an approximately 10% discount from baseline offer. This results in offers of $105 per seat, which gives a total bid amount of $101×8=$840. These exemplary algorithms are just possibilities; other seat pricing algorithms can be used. Additionally, it should be understood that there is a myriad of ways for bidders to control processes for generation of data inputs, and the exemplary alternative bid generation control window 800 is just one possible solution that can be used with the inventive system.

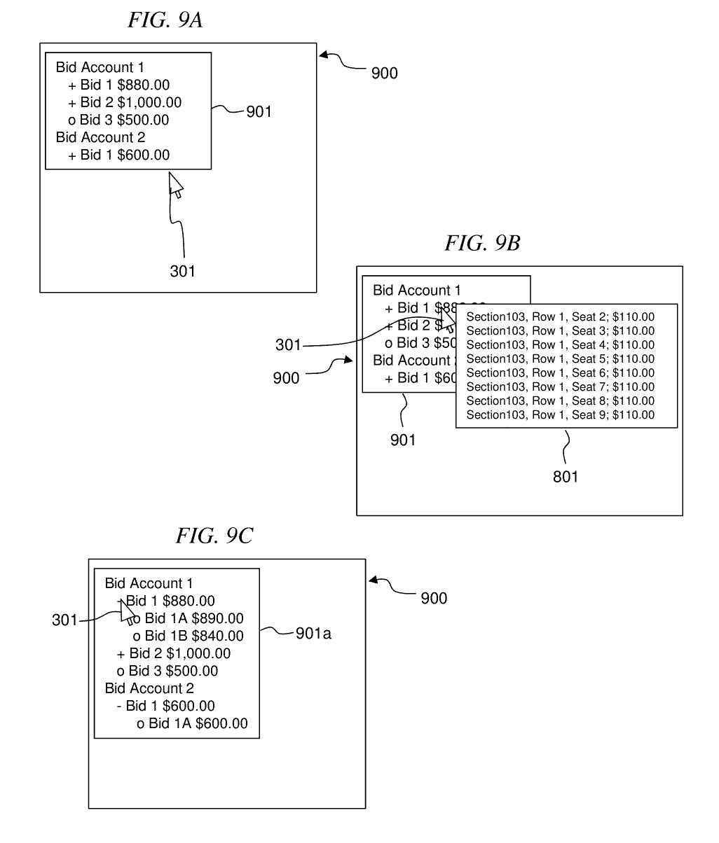

After generating bids, a bidder may wish to examine and edit the bids. Editing can occur both as part of the generation process, before the bids are submitted into the auction, and also at a later time during the bid window, when a bidder wishes to examine the competitiveness of the bids and either cancel them or increase the amount, in an effort to improve the chances of winning. As part of this managing and editing process, the bidder may encounter GUI displays similar to those shown in FIGS. 9A-C. FIG. 9A illustrates a bid account summary window 900, having a bid management box 901. Bid management box 901 displays the ongoing exemplary bid, illustrated in FIG. 6A, and labeled “Bid 1.” Bid management box 901 also indicates that the bidder is using two bid accounts, labeled “Bid Account 1” and “Bid Account 2,” although the bidder may optionally have the opportunity to give these different bid accounts more descriptive names. As illustrated, Bid Account 1 has three baseline bids, labeled “Bid 1,” Bid 2″ and “Bid 3.” To the left of both Bid 1 and Bid 2 are “+” (plus signs), indicating that there are automatically generated alternative optional bids that correspond to these baseline bids. There is no such symbol adjacent to Bid 3, indicating an absence of alternative optional bids tied to that baseline bid. Also, there is a “+” (plus sign) annotating the single displayed baseline bid (“Bid 1”) in Bid Account 2, indicating the existence of automatically generated alternative optional bids. This annotation is merely one possibility of indicating the presence or absence of optional alternative bids.

A comment is warranted here, regarding the two different bid accounts. In accordance with the described operation of the auction, if any one of the bids in Bid Account 1 are provisionally accepted (which are: Bid 1, Bid 2, Bid 3, and all automatically generated alternative optional bids that had been generated from Bid 1 and Bid 2), then all other bids in Bid Account 1 will be provisionally canceled. However acceptance of any of the bids in Bid Account 1 will not affect the viability of the bids in Bid Account 2, and also the reverse. This is for the exemplary embodiment. It could be possible in some variations of the inventive system to have a hierarchical system of mutually exclusive bid accounts. However, for this exemplary embodiment, Bid Account 1 and Bid Account 2 will be handled independently.

FIG. 9B illustrates the result of the bidder moving cursor 301 over the display of baseline Bid 1. The software senses the position of the cursor and displays bid summary window 801 as a convenience (or sometimes, possibly, an annoyance) for the bidder. FIG. 9B illustrates the result of the bidder moving cursor 301 to the “+” (plus sign) to the left of Bid 1 and clicking. The automatically generated alternative optional bids that had been generated for Bid 1, as described previously, are displayed in an expanded bid management box 901a of FIG. 9C. As described previously, one bid, here labeled as “Bid 1A,” has a total offer price of $890, and the other, here labeled as “Bid 1B,” has a total offer price of $840. Thus, Bid 1A corresponds to FIG. 6B and Bid 1B corresponds to FIG. 6C. Also displayed in expanded bid management box 901a is a single automatically generated alternative optional bid for Bid 1 of Bid Account 2. This display indicates that the bidder wanted to examine the automatically generated alternative optional bids for Bid 1 of Bid Account 1 and Bid 1 of Bid Account 2, but has not yet expanded Bid 2 of Bid Account 1 to examine those. In some embodiments, the bidder could rename the bids, including possible the automatically generated alternative optional bids, in addition to renaming the bid accounts. One possible method of renaming the bid accounts and bids would be to place cursor 301 over a label and right-clicking the mouse to display a text entry box.

The display of the various GUI windows described thus far would typically require some sort of logical control, preferably a balanced mixture of automation for convenience, and also manual control for flexibility. One exemplary scheme is illustrated in FIGS. 10A-E. The described exemplary embodiment has a hierarchical menu that enables a bidder to manage multiple bid accounts and bids. FIG. 10A shows GUI menu bar 303, and cursor 301 hovering over a user account sub-menu box 1001. In some embodiments, when cursor 301 hovers over the label “My Account” for a sufficient length of time, user account sub-menu box 1001. User account sub-menu box 1001 will remain displayed for as long as cursor 301 remains within box 1001 or over the “My Account” label. This is a common GUI menu operation, used by many software applications and internet browsers. Alternative GUI menu operation is possible, though. As illustrated, user account sub-menu box 1001 displays multiple options for the user to manage the overall account. These options include entering and editing personal identifying information, entering and editing payment information, and entering and editing account holder preferences. The personal information and payment information needed or used by the exemplary embodiment may be the standard information needed or used in other online shopping and auction accounts. This includes name, address, and credit card or other payment account information. Account holder preferences can include a preferred method of contact and whether to approve the auction host and other parties clogging up the user account's registered email address inbox with spam emails, purported to be announcements of upcoming events and discounts.

FIG. 10B illustrates cursor 301 hovering over a bid account sub-menu box 1002. The illustrated user options include creating a new bid account, deleting a bid account, and managing a bid account. If the embodiment permits renaming bid accounts, presumably one or more of these menu options would lead to a text entry box for receiving that input. If the embodiment permits making bid accounts mutually exclusive, the Manage Bid Accounts menu option would lead to GUI window for managing the bid account relationships. The menu options indicated here, and in FIG. 10A, correspond to the actions that occur in some of boxes 101-106 of method 100, and illustrated in FIG. 1.

FIG. 10C illustrates cursor 301 hovering over a bid sub-menu box 1003. The illustrated user options include creating a new bid, deleting a bid, editing a bid, listing bids, and making payments for bids. A bidder selecting the New Bid menu option could then trigger the software to launch GUI window 300, as illustrated in FIG. 3. A bid entry process could then commence, as described thus far. A bidder selecting one of the Cancel Bid or Edit Bid menu options could then trigger the software to launch bid account summary window 900, as illustrated in FIG. 9. Selection of a particular one of those menu options could also set other logical flags in the software to trigger other actions. For example, selecting Edit Bid would display bid account summary window 900 with a logical flag set so that the bidder clicking on a particular bid opens a text entry window, whereas selecting Cancel Bid would display bid account summary window 900 with a logical flag set so that the bidder clicking on a particular bid opens a confirmation window that the selected bid is to be deleted. A bidder selecting List All could then open a non-editable list, optionally similar to bid account summary window 900, but formatted better for printing.

In the illustrated embodiment, the Payment option of bid sub-menu box 1003 is different than the Payment Information option of user account sub-menu box 1001 (as illustrated in FIG. 10A). Whereas the Payment Information option of user account sub-menu box 1001 is for entry of payment account information, the Payment option of bid sub-menu box 1003 is for payment authorization, such as perhaps authorizing per-bid fees that an auction holder may charge in order to cut down on attempted exploits by malicious actors or “bots” that could disrupt the orderly operation of an auction. Similar payment authorization menu items could also appear in bid account and user account sub menus of some embodiments, to handle the user account fees and bid account fees that are charged in boxes 103 and 105, respectively, of method 100 (illustrated in FIG. 1). Alternatively, rather than having a menu item, payment authorization may be a step that occurs in a guided process of information entry. There is a myriad of existing methods that online commerce websites use to trigger prompts for a user to authorize a payment. For embodiments that required fees for any of a user account setup, a bid account setup and a bid entry, the payment of the required fees should be a prerequisite for participating in the auction event.

The timing and necessity of fees for accounts and bids can vary widely. In some embodiments, it may be preferable to wait to charge any fees (user account setup, bid account setup and per-bid fees) until after a user has prepared multiple bid accounts, entered bids for those accounts, and is ready to enter the bids into the auction. This is akin to a “check out” procedure in a common online e-commerce website, in which a user finishes “shopping” before making payment. In the context of the inventive system, however, the bidder (i.e., the user) is purchasing the right to participate in an auction that is, hopefully, free of interference by “bots” and malicious actors that are attempting to exploit the auction process in some way, and make it unfair or unappealing to legitimate users. Some auction hosts may offer to use some of the paid fees, or a portion, as credits toward payment of a winning bid in the current or future auction. Options include using only bid fees paid for a winning bid toward that bid settlement, or perhaps all fees, whether user account fees, bid account fees and bid fees for even unsuccessful bids, can be used as credits. In some embodiments, once a bidder has paid for a user account and bid accounts, those accounts will be persistent and available for use in subsequent auctions with the same auction host, until those accounts are canceled by the user. Also, in some embodiments, paying the fees at this point could also trigger the auction host to verify the bidder's ability to pay for the highest bid in each bid account, using the provided payment account information. In such embodiments, if a bidder's credit card is declined for a provisional test reservation of the charges that could occur if that bidder was successful in all bid accounts, then the fees would not be charged, the bids would not be entered into the auction, and the bidder would be notified of the payment account problem.

In FIG. 10D, an edit bid sub-menu 1004 appears, that is hierarchically beneath bid sub-menu box 1003. One method for controlling the appearance of edit bid sub-menu 1004 is for the bidder to permit cursor 301 to hover over the “Edit Bid” label. Edit bid sub-menu 1004 is dynamically generated, using the existing bids that the bidder has entered (and not yet canceled). Using the ongoing exemplary bid process, the Bid Account 1 and Bid Account 2 accounts, as illustrated in FIG. 9A, had already been created by the bidder. If the bidder had created an additional bid account, had renamed any of the bid accounts, or had deleted a bid account, then the content of edit bid sub-menu 1004 would reflect that option. In some embodiments, a new bidder, who had not yet created any bid accounts, would encounter a grayed-out (inactive) “Edit Bid” label and the software would not generate an edit bid sub-menu 1004. In FIG. 10E, a second-tier edit bid sub-menu 1005 is illustrated, indicating the hierarchical and dynamic operation of the menu system of FIGS. 10A-E. Presumably, to have this view displayed, the bidder had first hovered cursor 301 over the “My Bids” label, the moved cursor 301 to hover over the “Edit Bid” label, then moved cursor 301 to hover over the “Bid Account 2” label, and now sees indications of both a baseline bid (“Bid 1”) and a single automatically generated optional alternative bid (“Bid 1A”) that had previously been generated for that baseline bid. In the exemplary bid process, these same bids are also illustrated in expanded bid management box 901a of FIG. 9C.

More detail will now be provided on the auction event itself, particularly the process of by which a sales parameter is optimized. It should be noted that the only way to truly ensure a global optimization, as opposed to a local optimization, is to perform an exhaustive test of all possible sales configurations. Such an exhaustive search may be impractical due to the long computation times. Additionally, the marginal return for the auction host may not justify the additional delay in reaching a final result. That is, a relatively quick solution search, testing only a limited number of candidate sales configurations, could produce a solution (a local optimum) that is likely to be relatively close to the global optimum. Options for a smart limited search include a guided search with a random walk, a sensitivity analysis, and a genetic algorithm. Some methods of searching for functional optima, given a large set of parameters, is well-known in the art. What will be described in more detail is a guided search with a random walk.

FIG. 11 illustrates a GUI control window for the auction controller to use for performing the auction calculations and bid selection. Whereas FIGS. 3-10E described the bidding process as seen by a bidder, FIG. 11 shows the other side of the auction process, specifically an auction optimization control window 1100 that is used by the auction host to manage the auction event calculations. This control window 1100 is presented either by application software or a browser, based on the implementation of the host-side auction software. The illustrated embodiment of action optimization control window 1100 has two sides: a starting point optimization parameter selection window and a progression option selection window. These control which starting points and progression methods will be used. These search parameters were introduced in the description of FIG. 2, for example in the description of box 211, and a possible search method will be further explained in the upcoming description of FIG. 12.

In a guided search, the automated auction calculation process requires some criteria to identify the initial provisionally accepted bid. This then starts the first round of provisional cancelations, and the auction event calculations can the “walk” through the remaining bids to arrive at a candidate sales configuration. Some possible criteria are illustrated in auction optimization control window 1100, along with an indication (i.e., the “X”) that the auction host will use each of the options. The larger the set of options that is used, the more closely the resulting discovered local sales parameter optimum will be to a global optimum. However, more search options will incur higher computational cost, resulting in a longer delay. For small arenas with few seats, this may not be a problem. However, for larger venues, the auction host may desire to eliminate some of the options, in order to increase speed. One possible method of operating auctions would be to try all search parameters for early auctions, endure the long computation times, and identify those search parameters that most often result in a final sales configuration. If a reliable trend is noticeable, then future auctions can jettison unproductive search options to improve speed.

Illustrated starting point options, in the order listed, are (1) using the bid containing the highest individual seat offer out of all of the bids involved in the auction; (2) using the bid with the highest total value; (3) using the bid with the highest number of seats (and of a tied set of bids, the one with the highest total value, with those ties resolved randomly); (4) using the bid that had been entered (and paid for, if necessary) earliest in the bid open window, or carried over from a previous auction of tickets for the same event; (5) a bid in a randomly selected bid account; (6) a bid randomly selected out of all bids in all bid accounts; and (7) some user-defined criteria that is defined in a selected optional control file. For the randomly selected bids, the selections of a starting point could optionally be limited to baseline bids. In the illustration, the auction host has set the auction calculation control to try 10 randomly selected bid accounts and 15 randomly selected bids. As illustrated, auction optimization control window 1100 indicates a total of 4+10+15+1=30 starting point trials for each progression option. This will result in the calculation of at least 30 candidate sales configurations, from which the most optimum will be selected. In actual practice though, the number of candidate sales configurations for a guided search will actually be the number of starting point options multiplied by the number of progression options. (Note that, for a sensitivity analysis optimization, which should converge on an optimum, the number of trials is typically unpredictable.)

The indication of a user-defined (by the auction host, not a bidder) starting point illustrates the flexibility of the inventive system. The illustrated embodiment includes the ability for a user to define a new rule set for selecting a starting point that is not already defined in the existing software. This permits an auction host to include a search type that had not been envisioned by the software programmers, but which the auction host believes to produce superior results over the pre-defined search options. The rule set may be in a human-readable ASCII TXT file, an XML file, or in binary format. The user-defined rule set file preferably is able to accommodate multiple new rules. Thus, although the count previously calculated was for a minimum of 30 starting point trials, if the selected file, here identified as “C:\User\wilson_auction\control\start_rules.txt,” contains more than just a single user-defined rule, the starting point trial count will be correspondingly higher.

Illustrated progression options, in the order listed, are (1) using the bid containing the next highest individual seat offer out of all of the bids remaining in the auction; (2) using the remaining bid with the highest total value; (3) using a bid with a seat that is adjacent to the latest provisionally accepted bid; (4) using a remaining bid that is closest to the stage, according to some distance calculation that weights the rows and distance from the center or edge of that row); (4) using the remaining bid that had been entered (and paid for, if necessary) earliest in the bid open window, or carried over from a previous auction of tickets for the same event; (6) a remaining bid in a randomly selected bid account; (7) a remaining bid randomly selected out of all bids in all bid accounts; and (8) some user-defined criteria that is defined in a selected optional control file. For the randomly selected bids, the selections may prefer baseline bids, if any remain within the randomly-selected bid account. In general, during the parsing of bids for provisional acceptance in an auction event, some baseline bids will have been canceled, leaving only the optional bids. In the illustration, the auction host has set the auction calculation control to try 11 randomly selected bid accounts and 14 randomly selected bids. As illustrated, auction optimization control window 1100 indicates a total of 5+11+14+1=31 progression options. Using the previously-mentioned count of 30 starting points, and this count of 31 progression options, at least 930 candidate sales configurations will be tested. The user-defined rule file for progression options, “C:\User\wilson_auction\control\prog_rules.txt” may preferably contain more than just a single progression rule set, increasing the number of calculated candidate sales configurations. The use and format of a file containing user-defined progression option rules may be equivalent to the description of the user-defined starting point rule set file.

Further steps may be taken by the auction host, in order to minimize the effect of malicious actors on the auction process. For example, a malicious actor may attempt to exploit the auction system, in part by attempting to control at least one of the starting point selections. To do this, the malicious actor may include so many seats in a bid that it has the highest total value. So, the auction host may limit the number of seats permitted in a single bid to some number that the auction host believes would actually be requested by a legitimate bidder. Some auction hosts may permit exceptions, upon a showing of a genuine interest in a large block of seats by a particular bidder. Also, it should be noted that a different set of options than those shown in FIG. 11, for both starting points and progression, may be used in some embodiments.

With the auction hosts' controls now described, the auction process, initially described in FIGS. 1 and 2, may be revisited and explained in greater detail. FIG. 12 illustrates a method 1200 that is integrated with method 200, as illustrated in FIG. 2. Method 1200 includes portions of method 200, but offers insight into additional defined steps. In actual practice, software implementing methods 200 and 1200 could accurately be described with either FIG. 2 or FIG. 12, with each figure emphasizing different aspects of the software functionality.

Method 1200 starts with box 1201, denoted as the start of the auction optimization. A random number seed is obtained in box 1202, which is part of a process of determining an initial seed to use for the auction process, and initializes any random number generators used for the later bid selections. In box 1203, a starting point option is used, indicated by the index number “J”, which is merely an abstraction for counting in this example. The starting point options could be those listed in FIG. 11 that had been selected by the auction host. Box 1204 indicates the performance of boxes 204 through 206 of method 200. In box 1205, a progression option is used, indicated by index number “K”, which is merely an abstraction for counting in this example. The progression options could be those listed in FIG. 11 that had been selected by the auction host. Box 1206 indicates that the progression of provisionally accepting a bid (according to the current progression option) and then canceling other bids in the same bid account and all overlapping bids in all bid accounts, continues while bids remain for consideration.

When the available bids have either been provisionally accepted or canceled (i.e., all the bids have been considered), it is possible to calculate the sales parameter value for the current sales configuration. The current sales configuration is indicated by the index number “N”, which is merely an abstraction for counting in this example. If enough sales configurations had been tested, according to how the auction host set up the search, then box 209 (shown in both FIG. 2 and FIG. 12) determines that termination criteria had been met, resulting in a “Yes” condition. Termination criteria can include that all of the search parameters, described along with FIG. 11, had been searched and that any sensitivity analysis search and genetic algorithm search had either met convergence criteria or had reached a maximum trial count. If the termination criteria had been met, method 1200 exits into box 212 of method 200.

If, however, termination criteria had not been met, method 1200 increments N by proceeding through box 210 (which also appears in FIG. 2) to box 1207. It should be noted that the processes of box 211, denoted as “Change selection basis” in FIG. 2, and also box 203, are illustrated in greater detail with boxes 1207-1209 and 1203-1206 of FIG. 12.

Proceeding through box 1207, the index value K is incremented in method 1200. This simply means that the next progression option in the list of selected progression options is to be used for the sales parameter value calculation of the next candidate sales configuration. In box 1208, method 1200 determines whether all selected progression options had been used for the current starting point. If not, then method 1200 returns to box 1203 to use the current progression option. If however, all progression options had been used, method 1200 instead increments K in box 1209, moving to the next starting point option, and resets the counter for the progression option. Method 1200 then continues with box 1203. These loops, going back through box 1203 will exhaust all combinations of the selected starting point and progression options. It should be understood though, that in actual practice, an auction host may intervene to stop a guided search and force method 1200 into box 212, if the calculation time is running too long.

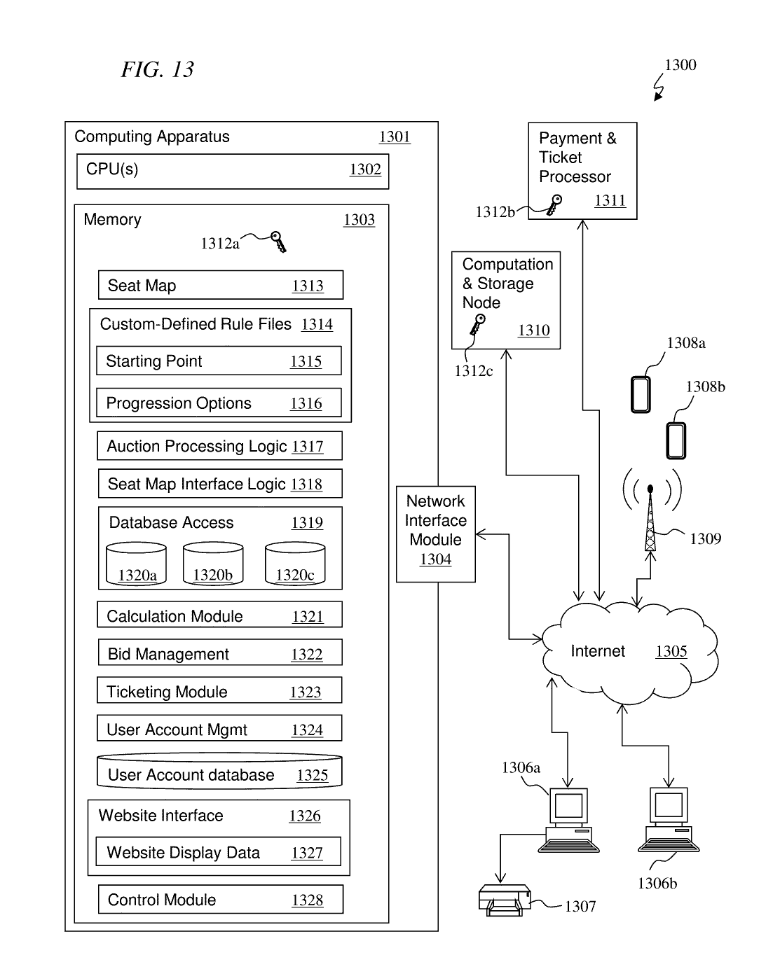

Turning now to the computer system requirements for running software that implements the inventive methods, a computer system 1300 is illustrated in FIG. 13. Computer system 1300 is able to performing electronic auctions as described herein. Computing apparatus 1301 comprises CPU(s) 1302 and a memory 1303 that is coupled to CPU 1302. It should be noted that, due to the commonality of multi-CPU computer systems, any mention herein of a CPU in singular is intended to include multi-core CPUs and also networked CPUs. Computing apparatus 1301 further comprises a network interface module 1304 that permits computing apparatus 1301 to communicate with other computer systems.

As illustrated, computing apparatus 1301 is connected to the internets 1305, permitting communication with bidder computers 1306a and 1306b. Computing apparatus 1301 is also in communication with bidder mobile devices 1308a and 1308b through wireless system 1309. Wireless system 1309 could be a cellular network, WiFi, or any other suitable network. Mobile devices 1308a and 1308b could serve as the tickets to enter an event by displaying an image, such as a barcode or other scannable image, on the screen. Use of mobile devices as ticket surrogates is well-known in the art.

Computing apparatus 1301 is yet further in communication with a computation and storage node 1310 and also a payment and ticket processor 1311. Computation and storage node 1310 is an optional part of system 1300 and could be a near duplicate of computing apparatus 1301 for load balancing or reliability purposes, or could instead be a specialized system that serves only a portion of the computation and storage needs. For example, if computing apparatus 1301 provides the interface service with bidders' devices, the actual time-consuming auction calculations could optionally be offloaded (in part or in whole) from computing apparatus 1301 to computation and storage node 1310. Alternatively, computation and storage node 1310 could act effectively as a cloud storage site for any of the user or auction data, or auction historical data that is used for speeding up future auctions.

Payment and ticket processor 1311 could be a bank that accepts credit cards or performs other online e-commerce transactions (such as PayPal) that provides the actual funds transfers from bidders to the auction host, event organizer or any other entity that is collecting the ticket payment funds. Additionally, payment and ticket processor 1311 can represent a contracted ticketing service, as previously mentioned, that accepts a list of auction winners, along with their contact and payment information, and actually processes the ticketing and distributes the tickets in electronic or paper form. Ticket distribution is well-known in the art.

As illustrated, memory 1303 within computing apparatus 1301 contains multiple modules of data and logic, although it should be understood that these data and logic modules could be duplicated or moved to other cooperative computing systems, for example computation and storage node 1310, and payment and ticket processor 1311. In an attempt to perform cooperative operation, while minimizing the effects of hackers and other malicious activity, computing apparatus 1301, computation and storage node 1310, and payment and ticket processor 1311 all communicate securely, using cryptographic systems 1312a-1312c.

Memory 1303 contains a seat map 1313 of the venue for which tickets will be auctioned. Seat map 1313 could be hierarchical, showing the venue at different resolutions (as depicted in FIGS. 3 and 4A) and should preferably have a corresponding GUI map that links a cursor position within a displayed image with a particular seat. Memory 1301 also contains a file system 1314 that holds information for custom-defined auction processing rules, as discussed in the description FIG. 11. These are starting point rule file 1315 and progression option rule file 1316. Any other files containing software option selections and additional rules that the auction host desires to customize the software operation can also be stored here, for example limits on the number of bids per bid account or per user account, and limits on the number of seats per bid. An embodiment of the inventive system contains operations that most auction hosts will need or use, stores preference data for the specific auction host that is using the software, and also permits plug-in rule sets. Examples of plug-in rule sets include the starting point and progression options mentioned earlier, the amount of fees charged for users to set up accounts and enter bids, limits on the bid numbers and amounts, and other behavior that the auction host wishes to customize differently than the original software.

Auction processing logic 1317 is the computing instruction set that conducts inventive auction operations as described, and is supplemented by the custom rule files 1314. That is, in an exemplary embodiment, auction processing logic 1317 is the default logic that is distributed with all copies of the auction processing software. Seat map interface logic 1318 links the display of a seat map with operations that are performed for a bidder, and interprets GUI selections by a bidder. For example, seat map interface logic 1318 controls the appearance of seat information box 402 and seat information box 502, as well as interpreting a mouse click to make seat information box 402 editable. (Seat information box 402 and seat information box 502 are shown in FIGS. 4A-5B.)

Database access 1319 is illustrated as having multiple databases, 1320a-1320c; it provides the data interface among the auction processing logic 1317, seat map interface logic 1318 and other modules within memory 1303 that are accessed by bidders and the auction host. For example, as bids are entered by bidders, they may be stored in database 1320a. Database 1320b may contain candidate sales configurations that are considered during the auction process. Database 1320c may contain a record of auction winners that is sent to payment and ticket processor 1311 for ticket sales completion and distribution. It should be understood that multiple database uses, configurations, and interactions are possible.

Memory 1303 is further illustrated as containing calculation module 1321. Calculation module 1321 performs the calculations of the sales configuration options, cooperating with auction processing logic and custom-defined rules 1314 to march through the different possible combinations of winners. Subject to the auction progression constraints, defined by other modules, calculation module 1321 provides the numbers that are used in the optimization. Auction processing logic 1317 uses those numbers to decide on the final sales configuration.

Bid management module 1322 interfaces with the website that bidders see, or any user-device application software that permits a user to enter bids with reduced internet traffic. Bid management module 1322 can use any rules from custom rule files 1314 to a single bidder's number of bids to some limit, enforce any possible limit on the number of seats, enforce auction minimums and other monetary constraints, control the charge of some fees, and perform other “behind the scenes” operations that permit bidders to enter bids within the constraints set by the auction host. For example, bid management module 1322 may be the time-keeper for the bid window, although that function could be handled elsewhere.

Ticketing module 1323 controls the ticket processing and distribution, based on the final sales configuration, and may actually be within payment and ticket processor 1311. Electronic ticket processing and distribution is well-known in the art. User account management module 1324 handles user account creation and editing, and stores the information (including users' payment information) in user account database 1325.

Website interface 1326 handles the publishing of website display data 1327 for bidders to use for opening and managing accounts and bidding in auctions. Website display data 1327 includes a display version of seat map 1313, as well as other information necessary to create the user displays of FIGS. 3-10E. Control module 1328 performs other software control functions not already described, including operation by the auction host and display of the auction optimization control window 1100, illustrated in FIG. 11.

Using the systems and methods described thus far, operation of an exemplary system may be described. The exemplary method of electronic auction for optimizing an event ticket sales parameter is executable by a processor, for example CPU 1302 of FIG. 13, the exemplary method comprises the following processes: A node on a computer network (for example computing apparatus 1301) has a memory and one or more processors. A bid window is opened on that node, for example by setting a condition on a website and associated computer systems to begin accepting bids in the form of network messages.

The node receives, over a computer network, a set of mutually exclusive bids from a first bid account, a set of mutually exclusive bids from a second bid account, and a set of mutually exclusive bids from a third bid account. All three of the bid accounts are different, and each of the three sets comprises a plurality of bids. In this exemplary operation, bids from at least two different bid accounts overlap. Other bids may be received from multiple additional bid accounts. The received bids are stored in a database in the memory, the sets of received bids together forming a plurality of received bids. The bid window is then closed, for example by the website and associated computer systems being set to a condition in which bids are no longer accepted.

A processor then begins calculating a sales parameter value for the plurality of received bids in a first candidate sales configuration, using the plurality of received bids. The processor also calculates a second and a third candidate sales configuration, with each candidate sales configuration having a different set of provisionally accepted bids than the others. Additional sales configurations may also be calculated. The candidate sales configurations differ because at least one of the starting point and progression options differ (or use different random steps) among the different sets of calculations. While calculating a sales parameter for a candidate sales configuration, the exemplary system (a) provisionally accepts a bid from a bid account, (b) provisionally cancels all other bids in the same bid account as the provisionally accepted bid, (c) provisionally cancels all bids in other bid accounts that overlap with the provisionally accepted bid, and (d) for a plurality of iterations, repeats steps a through c for remaining bids.

Responsive to calculating the plurality of sales parameter values, the exemplary system selects the candidate sales configuration to be the final sales configuration which, out of all of the calculated feasible sales configurations, best optimizes the sales parameter. The auction host defines the parameter to optimize; one example is maximizing ticket sales revenue. The bids that had been provisionally accepted in the final sales configuration become the finally accepted the bids, and the tickets transactions may then be performed. In this exemplary operation, at least one finally accepted bid does not optimize the sales parameter for the event tickets within that finally accepted bid. What this means is that tickets, for at least one set of seats, were sold to a bidder that was not the highest bidder. So, for that set of seats, the auction host did not maximize ticket sales revenue. However, in the larger scheme, because of the mutually exclusive nature of the bids, the higher bidders may have been winners of the bids for different seats, and thus the auction host collected more money in the aggregate.

There are optional features in the exemplary system. For example, the ticket bids could be for season tickets, which are for multiple events spanning multiple dates. Additionally, as a convenience for the bidders, the system may automatically generate alternative optional bids, for example a shifted set of seats in the same row as for a baseline bid entered by the bidder. Based on the locations of the seats in the automatically generated alternative optional bids, some seats may have a lower or higher automated offer.

Although the invention and its advantages have been described herein, it should be understood that various changes, substitutions and alterations can be made without departing from the spirit and scope of the claim. Other auctions can benefit from the mutually exclusive bid operation, for example auctions on jewelry, automobiles, and other high-priced goods. Moreover, the scope of the application is not intended to be limited to the particular embodiments described in the specification. As one of ordinary skill in the art will readily appreciate from the disclosure, alternatives presently existing or developed later, which perform substantially the same function or achieve substantially the same result as the corresponding embodiments described herein, may be utilized. Accordingly, the appended claims are intended to include within their scope such alternatives and equivalents.

What is claimed is:

1. A method of electronic auction for optimizing an event ticket sales parameter, the method executable by a processor, the method comprising:
at a node on a computer network, the node having a memory and one or more processors, opening a bid window;
receiving, at the node, a set of mutually exclusive bids from a first bid account;
receiving, at the node, a set of mutually exclusive bids from a second bid account, the second bid account being different than the first bid account;
receiving, at the node, a set of mutually exclusive bids from a third bid account, the third bid account being different than the first and second bid accounts,
wherein each of the three sets comprises a plurality of bids, and
wherein bids from at least two different bid accounts overlap;
storing the bids in a database in the memory, the sets of received bids together forming a plurality of received bids;
at the node, closing the bid window;
calculating, by the processor, a sales parameter value for the plurality of received bids in a first candidate sales configuration;
calculating, by the processor, a sales parameter value for the plurality of received bids in a second candidate sales configuration, the second candidate sales configuration having a different set of provisionally accepted bids than the first candidate sales configuration;
calculating, by the processor, a sales parameter value for the plurality of received bids in a third candidate sales configuration, the third candidate sales configuration having a different set of provisionally accepted bids than the first and second candidate sales configurations;
wherein calculating a sales parameter for a candidate sales configuration comprises:
a. provisionally accepting a bid from a bid account;
b. provisionally canceling all other bids in the same bid account as the provisionally accepted bid;
c. provisionally canceling all bids in other bid accounts that overlap with the provisionally accepted bid; and
for a plurality of iterations, repeating steps a through c for remaining bids;
responsive to calculating the plurality of sales parameter values, selecting as the final sales configuration the candidate sales configuration that optimizes the sales parameter;
finally accepting the bids according to the final sales configuration,
wherein at least one finally accepted bid does not optimize the sales parameter for the event tickets included in that finally accepted bid; and
transacting the event ticket sales according to the finally accepted bids.

2. The method of claim 1 further comprising:
while the bid window is open, receiving additional sets of mutually exclusive bids from a plurality of additional different bid accounts; and
using the additional sets of mutually exclusive bids in the plurality of candidate sales configurations.

3. The method of claim 1 further comprising:
calculating a sales parameter value for each of a plurality of additional different candidate sales configurations; and
using the additional sales parameter values in the optimizing.

4. The method of claim 1 wherein optimizing the sales parameter comprises maximizing event ticket sales revenue.

5. The method of claim 1 wherein the event ticket sales are for seats for multiple events spanning multiple dates.

6. The method of claim 1 further comprising:
responsive to receiving a baseline bid from a bid account and also having an indication for the bid account that alternative bids with a shifted set of seats are acceptable, automatically generating, by the processor, at least one additional bid for the bid account, the additional automatically generated bid having a set of seats that are shifted from the seats of the baseline bid.

7. The method of claim 6 wherein the additional automatically generated bid has at least one seat with a lower offer price than the corresponding seat in the baseline bid.

8. The method of claim 6 wherein the additional automatically generated bid has at least one seat with a higher offer price than the corresponding seat in the baseline bid.
